(19) United States
(12) Patent Application Publication
(10) Pub. No.: US 2013/0195166 A1
(43) Pub. Date: Aug. 1, 2013

(54) Robust Frequency-Domain Equalization in Communications Receivers

(71) Applicant: Andres Reial, Malmo (SE)

(72) Inventor: Andres Reial, Malmo (SE)

(73) Assignee: TELEFONAKTIEBOLAGET LM ERICSSON (PUBL), Stockholm (SE)

(21) Appl. No.: 13/360,258

(22) Filed: Jan. 27, 2012

(51) Int. Cl. H04L 27/01

(52) U.S. Cl. 375/231

(57) ABSTRACT

MMSE equalization in the frequency domain is emulated by applying intermediate weights on a per-frequency-bin basis and re-scaling each bin output to recover proper MMSE scaling. Time-domain samples of a received signal are transformed into a frequency-domain representation of the received signal. A frequency-domain representation of a channel response for the radio channel is calculated, and a frequency-domain representation of impairments to the desired signal is generated, the frequency-domain representation of the impairments comprising an impairment covariance matrix for each of the frequency bins. A scaling factor for each of frequency bins is calculated, based on a bin-specific signal-quality estimate for each bin, and an equalized frequency-domain sample for each of the frequency bins is computed, as a function of the scaling factors, the frequency-domain representation of the channel response, and the generated frequency-domain representation of impairments. The equalized frequency-domain samples are transformed into an equalized time-domain sample sequence.

### BACKGROUND

The present invention generally relates to wireless communications receivers, and more particularly relates to techniques for equalization of received signals to improve receiver performance.

In wireless cellular networks, a received signal may be affected by numerous impairments. For example, in the downlink of a High-Speed Packet Access (HSPA) system, the signal from a base station serving a particular mobile terminal travels through a dispersive radio channel, leading to multi-user interference (MUI) between simultaneously transmitted signals spread by different spreading codes, as well as inter-symbol interference (ISI) among adjacent symbols in the signal intended for the mobile terminal. Furthermore, signals from neighboring base stations may also be simultaneously received by the mobile terminal, contributing additional interference that degrades the received signal quality.

A well-known and widely used approach for mitigating the impairments above is linear equalization. In its general minimum-mean-square-error (MMSE) formulation, a linear equalizer both whitens interference and extracts the desired signal. The interference whitening operation treats the entire impairment signal jointly, thus achieving a trade-off between inverting the dispersive channel and suppressing interfering signals, such as other-cell interference. The signal extraction step typically effects matching to the received waveform of the desired signal, i.e., matched filtering with respect to the radio channel, as well as despreading.

MMSE equalization can be carried out in several ways. One widely used approach is to perform equalization in the time domain. An example of this approach is the traditional chip-level equalization process carried out in many DS-CDMA systems. If the received samples containing information about an output sample at a given time are given by:

y=[y₁ . . . Y_{M}]^{T}, (1)

then the equalized output sample is formed as:

ŝ=w^{M}y, (2)

where the weights are formulated according to the MMSE construction:

w=r_{d}⁻¹h, (3)

Here,

r_{d}=E[yy^{H}]=rᵤ+hh^{H} (4)

is the signal covariance matrix (which should not be confused with rᵤ, the impairment covariance matrix), E[] represents the expected value function and h is the channel coefficient vector. For a single-antenna equalizer configuration with uniformly spaced contiguous taps, r_{d} has a Toeplitz structure built from the received signal auto-correlation sequence r_{y}:

r_{y}[i]=E[y[k]y[k−i]*], (5)

For other configurations, such as multi-antenna configurations, the structure may be less transparent, but is readily obtained from related principles.

The approach described above is carried out entirely in the time domain, using a time series of samples y of the received signal. An alternative to time-domain implementation is to carry out MMSE equalization in the frequency domain. Because of the well-known duality properties between time- and frequency-domain representations of signals, the time- and frequency-domain solutions offer equivalent performance potential. However, the total processing load may be smaller for the frequency-domain solution when fast convolution principles are used. In addition, the frequency-domain representation of the equalizer weights has the attractive property that per-bin (i.e., per-frequency) optimization of the weights achieves overall maximization of the signal-to-interference-plus-noise (SINR) for the desired signal.

In the following mathematical description of the frequency-domain equalization process, capital letter notation is used for frequency-domain quantities. Thus, X(k) stands for the k-th bin (i.e., k-th frequency) of the frequency-domain representation of a given quantity. The equalizer output for each frequency bin k is then given by:

Ŝ(k)=W(k)^{H}Y(k), (6)

where Y(k) is an L×1 vector whose l-th element contains the k-th bin of the transform of input sample sequence y, from the l-th receiver antenna, out of a total of L receiver antennas.

The time-domain chip sequence is recovered via an inverse transform of the entire equalized frequency-domain signal, i.e., from the vector Ŝ of equalized frequency-bin samples Ŝ(k), according to:

ŝ=IFFT└Ŝ┘, (7)

where IFFT[ ] represents the inverse fast-Fourier transform function.

The ideal MMSE weight vector (L×1) for each frequency bin k is formed as:

W(k)=R_{d}⁻¹(k)H(k) (8)

where H(k) is an L×1 channel estimate vector. Here, R_{d}(k) is the L×L signal covariance matrix, with element <m,n> given by the k-th bin of the transform of the cross-correlation sequence r_{y}^{m,n}[i]=E└yₘ[k]yₙ[k−i]* ┘ between the sample streams from antennas m and n.

While MMSE equalization is a well-known and thoroughly proven approach in many contexts, it is also well known that the MMSE solution is quite sensitive to the channel estimation quality. Accordingly, there is a need for an improved equalization weight formulation.

### SUMMARY

In several embodiments of the present invention, rather than calculating frequency-domain MMSE weights directly, MMSE equalization is emulated by applying intermediate weights on a per-frequency-bin basis and re-scaling each bin output to recover proper MMSE scaling for that bin. More particularly, if impairment covariance is used to compute the intermediate weights, rather than covariance of the received signal samples, the inherent MMSE sensitivity problem at each frequency bin may be circumvented, while still obtaining the required overall MMSE solution, flattening the signal spectrum of interest as desired.

In an example method for performing linear equalization of a desired signal received over a radio channel, time-domain samples of a received signal are transformed into a frequency-domain representation of the received signal. The frequency-domain representation of the received signal comprises a sample vector for each of a plurality of frequency bins. A frequency-domain representation of a channel response for the radio channel is also calculated, the frequency-domain representation of the channel response comprising a channel response vector for each of the frequency bins. Further, a frequency-domain representation of impairments to the desired signal is generated, the frequency-domain representation of the impairments comprising an impairment covariance matrix for the desired signal for each of the frequency bins.

A scaling factor for each of the plurality of frequency bins is computed, based on a bin-specific signal-quality estimate for each frequency bin, and then an equalized frequency-domain sample for each of the frequency bins is calculated, as a function of the scaling factors, the frequency-domain representation of the channel response, and the generated frequency-domain representation of impairments. Finally, the equalized frequency-domain samples are transformed into an equalized time-domain sample sequence.

In some embodiments, intermediate, frequency-domain, combining weight vectors for each of the frequency bins are calculated, based on the channel response vectors and the generated frequency-domain representation of impairments. In these embodiments, the equalized frequency-domain sample for each of the frequency bins is calculated as a function of the intermediate, frequency-domain, combining weight vectors, the scaling factors, and the generated frequency-domain representation of impairments. In some of these embodiments, final combining weights are first calculated, by applying each scaling factor to the corresponding intermediate combining weight vector. The final combining weights are then applied to the frequency-domain representation of the received signal to yield the equalized frequency-domain sample for each of the frequency bins.

The frequency-domain representation of impairments to the desired signal can be generated in several ways, some of which are described in detail below. In some embodiments, a signal covariance is calculated for each of the frequency bins and an estimate of the desired signal contribution for each of the frequency bins is calculated, as a function of the frequency-domain representation of the channel response vectors. For each frequency bin, the estimate of the desired signal contribution is subtracted from the calculated signal covariance to obtain the impairment covariance matrix for the frequency bin. In other embodiments, a parametric model of impairments for each frequency bin is generated, as a function of estimated receiver noise, or channel response estimates corresponding to at least one interference source, or both. This parametric model includes at least one fitting parameter, a value for which is then estimated, based on received signal samples. The impairment covariance matrix for each frequency bin is then calculated, using the parametric models and the estimated values for the fitting parameters.

Receiver circuits adapted to perform the techniques summarized above are also disclosed in detail in the following discussion. Of course, the present invention is not limited to the above-summarized features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a transceiver and a receiver, which includes a receiver circuit adapted to perform frequency-domain equalization according to the techniques disclosed herein.

FIG. 2 is a process flow diagram illustrating an example technique for performing linear equalization of a desired signal received over a radio channel.

FIG. 3 is a block diagram of a receiver circuit according to some embodiments of the present invention.

### DETAILED DESCRIPTION

While the MMSE equalization weight formulation is a well-known and thoroughly proven approach in many contexts, its use in frequency-domain equalization exhibits the unfortunate shortcoming that the solution is quite sensitive to the channel estimation quality. In particular, it may be shown analytically that errors in the estimation of the channel response H can lead to large deviations from the optimal weights, and thus cause significant performance degradation. Accordingly, there is a need for a frequency-domain equalization weight formulation that is more robust to imperfect channel estimates.

This need is addressed by several embodiments of the present invention. Rather than calculating frequency-domain MMSE weights directly, MMSE equalization is emulated by applying intermediate weights on a per-frequency-bin basis and re-scaling each bin output to recover proper MMSE scaling for that bin. More particularly, if impairment covariance is used to compute the intermediate weights, rather than covariance of the received signal samples, the inherent MMSE sensitivity problem at each frequency bin may be circumvented, while still obtaining the required overall MMSE solution, flattening the signal spectrum of interest as desired.

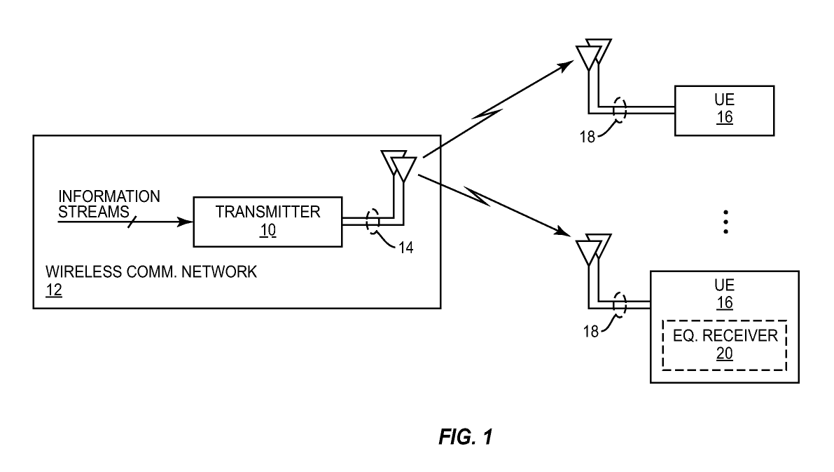

FIG. 1 illustrates an example wireless network in which these techniques can be applied. The wireless network illustrated in FIG. 1 includes a transmitter 10, which is part of a High-Speed Packet Access (HSPA) communication system 12, according to specifications developed by members of the 3 ^{rd}-Generation Partnership Project (3GPP). Transmitter 10 transmits signals corresponding to one or more information streams from antennas 14 to a plurality of targeted receivers, each of which may have one or several antennas. In the illustration, the targeted receivers are generically depicted as several wireless communication devices or user equipment (UE) 16, where each UE 16 includes two or more receiver antennas 18. Of particular interest here, at least one UE 16 includes a frequency-domain equalizing receiver circuit 20 that is configured to simplify and improve frequency-domain equalization in a potentially complex interference environment, through the use of intermediate, frequency-domain, combining-weight vectors for each of the frequency bins in the frequency-domain representation of the signal. As described in further detail below, these intermediate weights are in turn based on a frequency-domain representation of the estimated channel response and a frequency-domain representation of impairments to the desired signal.

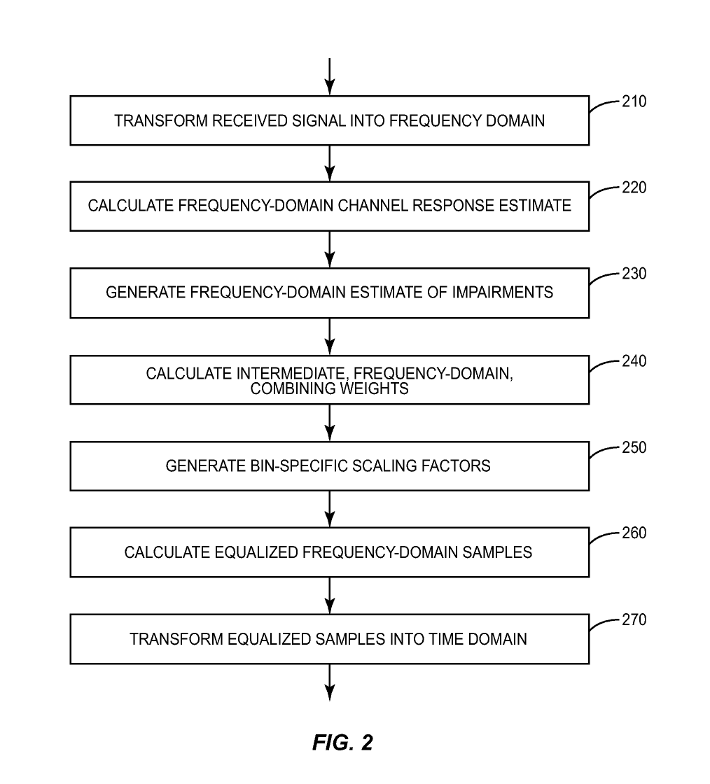

FIG. 2 illustrates processing logic for one embodiment of receiver circuit 20, which may comprise hardware or a combination of hardware and software. The illustrated process begins, as shown at block 210, with the transforming of time-domain samples of a received signal into a frequency-domain representation of the received signal. Because multiple receive antennas are used, the frequency-domain representation of the received signal will comprise a sample vector for each of a plurality of frequency bins, where each sample vector includes an element for each of the L receive antennas.

As shown at block 220, a frequency-domain representation of a channel response for the radio channel is also calculated. In some embodiments this may be done by first calculating a time-domain estimate of the channel response for each receiver antenna, using, for example, information about a known pilot signal included in the received signal, such as the Common Pilot Channel (CPICH) in the HSPA downlink. The time-domain channel response estimates can then be transformed into a frequency-domain representation of the channel response, which will then comprise a channel response vector for each of the frequency bins, where each channel response vector includes an element for each of the L receive antennas.

A frequency-domain representation of impairments to the desired signal is also calculated, as shown at block 230. As will be shown in further detail below, the frequency-domain representation of the impairments may be calculated using any of several approaches. One approach, for example, begins with calculating a received signal covariance for each of the frequency bins, and then subtracting an estimate of the own-cell rank-1 signal contribution, which is effectively an estimate of the desired signal contribution to the received signal covariance. In another approach, channel estimates for the channels between the UE and one or more other cells are used to construct a parametric model of the impairments; the model parameters are then estimated according to a conventional least-squares fitting approach. In either case, the frequency-domain representation of the impairments comprises an impairment covariance matrix for the desired signal for each of the frequency bins.

Intermediate frequency-domain, combining-weight vectors may then be calculated for each of the frequency bins, as shown at block 240, and are related to the frequency-domain representation of the channel response and the generated frequency-domain representation of impairments. Further, a scaling factor for each of the frequency bins is then calculated, as shown at block 250; the scaling factor is related to a the signal quality estimate for each frequency bin. An example calculation for the scaling factor is described below, in connection with Equation (12).

Finally, an equalized frequency-domain sample is calculated for each of the frequency bins, as shown at block 260, as a function of the intermediate combining weight vectors and the scaling factors. As shown at 270, the equalized frequency-domain samples are then transformed into an equalized time-domain sample sequence.

With the process illustrated in FIG. 2, instead of applying frequency-domain MMSE weights directly, MMSE equalization is emulated by calculating intermediate weights on a per-bin basis. Each bin's output is then re-scaled, to recover proper MMSE scaling for that bin. This approach allows the inherent MMSE sensitivity problem at each bin to be circumvented, while still obtaining the required overall MMSE solution and flattening the signal spectrum of interest as desired.

Conceptually speaking, frequency-domain MMSE equalization attempts to restore the flatness of the spectrum of the received signal by manipulating the frequency-domain signal representation directly, to undo the fading dips caused by the dispersive channel and to suppress interference. Since the Discrete Fourier Transform operation used to transform the received signals into the frequency domain effectively de-correlates the individual frequency bins, individually applying MMSE equalization to each bin leads to equivalent MMSE equalization in the time-domain. Importantly, the MMSE criterion includes restoring the uniform scaling of the bins in order to be left with a flat signal spectrum.

The technique described above and illustrated in FIG. 2 is explained in more detail in the following discussion. This discussion generally focuses on weight computation for a single frequency bin k, so the index k is omitted for conciseness in several of the equations that follow. Quantities that indicate estimates are indicated with the caret symbol^{A}.

Consider again the practical weight computation formula Ŵ=R_{d}⁻¹Ĥ, keeping in mind that the signal covariance matrix can be calculated as follows:

R_{d}=EₜHH^{H}+Rᵤ, (9)

where Eₜ is the average received power of the desired signal component in the frequency-domain sample vector Y and the impairment covariance matrix Rᵤ contains one or more components of other-cell interference and/or receiver noise. As noted earlier, Ĥ is an L×1 channel estimate vector, where l, is the number of antennas. In scenarios where the own-cell interference dominates over other-cell and receiver noise contributions, even small errors in the estimate Ĥ may lead to large errors in the MMSE weights. This is intuitive considering that, e.g., when Rᵤ=N₀I_{L} and N₀ is small, R_{d} is dominated by the rank-1 outer product term. It thus has a high condition number, its inverse will contain large entries, and the sensitivity to any deviations in the estimate Ĥ is high. Therefore, the use of the direct MMSE formulation may be disadvantageous at high SINR.

It has been shown that maximum-likelihood (ML) combining weights in the time domain are equivalent to minimum-mean-square-error (MMSE) weights in the frequency domain. Using this principle, intermediate combining weights, in vector notation, for each frequency bin can be calculated as follows:

Ŵ_{int =R}ᵤ⁻¹Ĥ, (10)

Then, final combining weights for each frequency bin are calculated, according to:

Ŵ=γŴᵢₙₜ, 11)

where the scaling factor γ is an SINR-dependent real coefficient:

$$γ = \frac{1}{1 + {\hat{H}}^{H} {R}_{u}^{- 1} \hat{H}} . \qquad ( 12 )$$

Since the impairment covariance matrix Rᵤ is typically much better conditioned than the signal covariance matrix R_{d}, this approach mitigates the sensitivity problems on a per-bin basis, in the presence of channel estimation errors.

In practice, for pulse-shaped signals like those used in the HSPA system, the weights for frequency bin k may be computed as:

W(k)=\hat{γ}(k)G(k)\hat{R}ᵤ⁻¹(k)Ĥ(k) (13)

where G(k) is the target raised cosine spectrum. This formulation accounts for the distortion that is intentionally introduced in the roll-off area. Including G(k) allows the equalizer output signal to account for the concatenation of a transmitter root-raised cosine (RRC) filter, an additive-white-Gaussian-noise (AWGN) propagation channel, and the receiver RRC filter. Since the frequency-domain equalizer generally attempts to whiten the entire output spectrum, omitting this term would force the equalizer to unnecessarily compensate for the raised-cosine roll-off. Of course, alternative weight formulations, where the target raised-cosine response does not need to be specified explicitly but may be embedded within other terms, may also be used in other embodiments.

The impairment covariance matrix Rᵤ may be obtained in several different ways. One technique uses a parametric estimation approach, in which an estimate of receiver noise, and/or channel estimates for other cells (i.e., interference sources) are used to construct a parametric model of the impairment covariance Rᵤ. In the general case, this model will take the form of the matrix:

$${R}_{u} = {\sum }_{j} {E}_{j} {\hat{H}}_{j} {\hat{H}}_{j}^{H} + {N}_{0} I . \qquad ( 14 )$$

The fitting parameters Eⱼ and N₀ are estimated using conventional techniques, e.g., according to a conventional least-squares (LS) fitting approach based on received signal samples. It should be noted that channel estimates used for parametric construction may be smoothed more heavily than the estimates used for weight computation.

In another, non-parametric approach, the signal covariance R_{d} can be used as a starting point. An estimate of the desired signal contribution to the signal covariance, e.g., a parametrically constructed estimate of the own-cell rank-1 signal contribution, is subtracted from the signal covariance to yield the impairment covariance:

Rᵤ=R_{d}−EₜĤĤ^{H}, (15)

An advantage of this non-parametric technique over the parametric one is that any other-cell interference is automatically accounted for, without any need for interference modeling.

Any of several known techniques for transforming quantities to and from the frequency-domain may be used. In one approach, time-domain sample sequences yₗ are transformed into the frequency-domain using a Fast-Fourier Transform (FFT) and the equalized sample stream ŝᵢ is transformed back into the time domain using an Inverse-FFT (IFFT), according to the overlap-add or overlap-save approach. Channel responses can be estimated in the time domain, e.g., using CPICH symbols, and transformed into the frequency-domain using DFT or FFT. Likewise, auto- and cross-correlation sequences r_{y}^{m,n} can be computed in the time domain and transformed into the frequency domain using DFT or FFT. Numerous alternative approaches for obtaining frequency-domain channel responses and received signal spectrum properties exist as well.

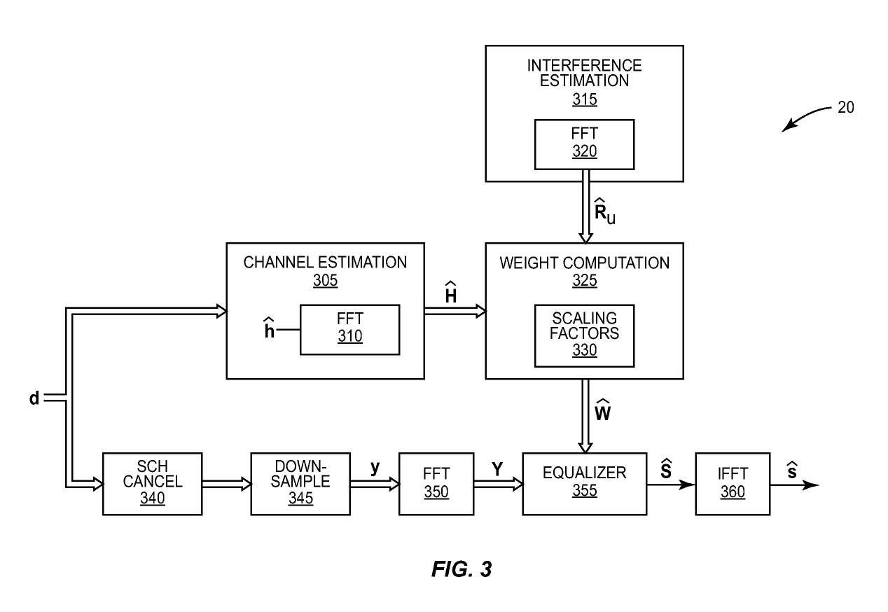

FIG. 3 is a block diagram illustrating the functional stages of a frequency-domain equalizing receiver circuit 20, according to several embodiments of the present invention. The receiver circuit 20 may be implemented in a wireless communication device or UE, for example, as shown in FIG. 1.

The upper branch of receiver circuit 20 depicts processing related to channel and interference estimation and weight computation. More particularly, the upper branch includes a channel estimation unit 305, which is configured in several embodiments to de-spread a pilot signal (such as CPICH) from the received signal d and to estimate the channel response based on the pilot signal. The time-domain channel estimate, ĥ, is then transformed to a frequency-domain representation of the channel response, Ĥ, in FFT unit 310.

Impairments to the received signal (i.e., interference and noise) are estimated in interference estimate unit 315. The inputs to interference estimation unit 315 are not shown in detail, since interference estimation may be done using any of several well-known techniques, several of which use differing quantities as inputs. In some cases, as discussed earlier, the impairments may be estimated in the time domain, in which case the resulting time-domain impairment estimates are converted to a frequency-domain impairment covariance matrix Rᵤ, using FFT circuit 320.

Intermediate combining weights are then formed in weight computation unit 325, using, for example, the formulation of equation (10). Scaling factors γ are also computed by weight computing unit 325, in scaling factor calculation unit 330; these scaling factors γ are related to the bin-specific signal quality, such as according to equation (12). The scaling factors γ and the intermediate weights are then used to calculate final combining weights Ŵ, which are supplied to the equalization unit 355, as shown in FIG. 3. Alternatively, and equivalently, the intermediate weights and the scaling factors γ may be supplied separately to equalization unit 355, which then applies them both to the frequency-domain representation of the input signal.

The lower branch of the receiver circuit 20 illustrated in FIG. 3 includes data flow processing. Synchronization channel (SCH) cancellation is first carried out in the time domain, by SCH cancellation unit 340, prior to transformation of the received signal to the frequency domain by FFT circuit 350. In some embodiments, the sampled signal sequence d (less the cancelled SCH component) is first down-sampled, using down-sampling circuit 345, to obtain time-domain sample sequence y. For example, the received signal may be oversampled at a rate of four times the bandwidth of the received signal. This rate is larger than is necessary and can unnecessarily increase the processing load on FFT circuit 350. Down-sampling circuit 345 may down-sample by a factor of two, for example.

Up to the equalization stage 355, the signals from the L receive antennas are processed separately, as indicated by the double lines. In the equalizer 355, the frequency-domain samples of the received signal Y are interference-rejection-combined, using the frequency-domain weights Ŵ, resulting in a single output sample Ŝ(k) for each frequency bin. The frequency-domain output from equalizer 355 is then converted to the time-domain with IFFT circuit 360, to yield an equalized time-domain series of samples ŝ. This time-series may be despread, using one or several spreading codes, to yield estimates of the transmitted data signals.

The processing in receiver 20 may be performed on a slot basis, or with a faster weight update rate in high Doppler scenarios. In some embodiments, the chip sample sequence for the whole slot is divided into several sub-FFT blocks, which are transformed into the frequency domain, equalized, and transformed back into the time domain.

As will be readily understood by those skilled in the art, receiver circuit 20 and its various functional blocks may be implemented using digital logic and/or one or more microcontrollers, microprocessors, or other digital hardware. The various functions of receiver circuit 20 may be implemented together, such as in a single application-specific integrated circuit (ASIC), or in two or more separate devices with appropriate hardware and/or software interfaces between them. One or more of the elements of FIG. 3 may be implemented on a processor shared with other functional components of a UE, for example. Alternatively, several of the functional elements of the receiver processing circuits discussed above may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Those skilled in the art will appreciate the cost, performance, and maintenance tradeoffs inherent in these design choices.

Channel estimation errors have been identified as a major limiting factor for frequency-domain equalizer performance. The techniques described herein make the MMSE frequency-domain equalizer architecture more robust against such errors. In addition, the frequency-domain equalization approach has the attractive property that per-bin processing achieves optimal SINR. Using these techniques, frequency-domain equalization may be utilized in a wider range of channel conditions and/or its performance for given conditions may be improved. Indeed, in simulated performance evaluations of the techniques described above, significant performance improvement with practical channel estimates was seen. While the development of these techniques was initially performed for application to High-Speed Downlink Packet Access receivers, the techniques are applicable to other systems and scenarios as well.

With these and other variations and extensions in mind, those skilled in the art will appreciate that the foregoing description and the accompanying drawings represent non-limiting examples of the methods and apparatus taught herein for performing linear equalization of a desired signal received over a radio channel, whether or not the received signal is an HSPA signal. As such, the inventive apparatus and techniques taught herein are not limited by the foregoing description and accompanying drawings. Instead, the present invention is limited only by the following claims and their legal equivalents.

What is claimed is:

1. A method in a communications receiver of performing linear equalization of a desired signal received over a radio channel, the method comprising:
transforming time-domain samples of a received signal into a frequency-domain representation of the received signal, the frequency-domain representation of the received signal comprising a sample vector for each of a plurality of frequency bins;
calculating a frequency-domain representation of a channel response for the radio channel, the frequency-domain representation of the channel response comprising a channel response vector for each of the frequency bins;
generating a frequency-domain representation of impairments to the desired signal, the frequency-domain representation of the impairments comprising an impairment covariance matrix for the desired signal for each of the frequency bins;
determining a scaling factor for each of the plurality of frequency bins, wherein said scaling factor is related to the signal quality for each frequency bin;
calculating an equalized frequency-domain sample for each of the frequency bins, as a function of the scaling factors, the frequency-domain representation of the channel response, and the generated frequency-domain representation of impairments; and
transforming the equalized frequency-domain samples into an equalized time-domain sample sequence.

2. The method of claim 1, wherein calculating the equalized frequency-domain sample for each of the frequency bins comprises calculating intermediate, frequency-domain, combining weight vectors for each of the frequency bins, based on the channel response vectors and the generated frequency-domain representation of impairments and calculating the equalized frequency-domain sample for each of the frequency bins as a function of the intermediate, frequency-domain, combining weight vectors, the scaling factors, and the generated frequency-domain representation of impairments.

3. The method of claim 2, wherein calculating the equalized frequency-domain sample for each of the frequency bins further comprises calculating final combining weights by applying each scaling factor to the corresponding intermediate combining weight vector, and applying the final combining weights to the frequency-domain representation of the received signal.

4. The method of claim 1, wherein generating the frequency-domain representation of impairments to the desired signal comprises:
calculating a signal covariance for the received signal for each of the frequency bins;
computing an estimate of the desired signal contribution for each of the frequency bins, as a function of the frequency-domain representation of the channel response vectors; and,
for each frequency bin, subtracting the estimate of the desired signal contribution from the calculated signal covariance to obtain the impairment covariance matrix for the frequency bin.

5. The method of claim 1, wherein generating the frequency-domain representation of impairments to the desired signal comprises:
generating a parametric model of impairments for each frequency bin, as a function of estimated receiver noise, or channel response estimates corresponding to at least one interference source, or both, the parametric model for each frequency bin comprising at least one fitting parameter;
estimating a value for each fitting parameter, based on received signal samples; and
calculating the impairment covariance matrix for each frequency bin from the parametric models and the estimated values for the fitting parameters.

6. A receiver circuit configured to perform linear equalization of a desired signal received over a radio channel, the receiver circuit comprising:
a transform circuit adapted to transform samples of a received signal into a frequency-domain representation of the received signal, the frequency-domain representation of the received signal comprising a sample vector for each of a plurality of frequency bins;
a channel estimation circuit adapted to calculate a frequency-domain representation of a channel response for the radio channel, the frequency-domain representation of the channel response comprising a channel response vector for each of the frequency bins;
an impairment estimation circuit adapted to generate a frequency-domain representation of impairments to the desired signal, the frequency-domain representation of the impairments comprising an impairment covariance matrix for the desired signal for each of the frequency bins;
a scaling factor estimation circuit adapted to determine a scaling factor for each of the plurality of frequency bins, wherein said scaling factor is related to the signal quality for each frequency bin;
an equalization circuit adapted to calculate an equalized frequency-domain sample for each of the frequency bins, as a function of the scaling factors, the frequency-domain representation of the channel response, and the generated frequency-domain representation of impairments; and
an inverse-transform circuit adapted to transform the equalized frequency-domain samples into an equalized time-domain sample sequence.

7. The receiver circuit of claim 6, wherein the equalization circuit is adapted to calculate the equalized frequency-domain sample for each of the frequency bins by calculating intermediate, frequency-domain, combining weight vectors for each of the frequency bins, based on the channel response vectors and the generated frequency-domain representation of impairments and calculating the equalized frequency-domain sample for each of the frequency bins as a function of the intermediate, frequency-domain, combining weight vectors, the scaling factors, and the generated frequency-domain representation of impairments.

8. The receiver circuit of claim 7, wherein the equalization circuit is adapted to calculate the equalized frequency-domain sample for each of the frequency bins further by calculating final combining weights by applying each scaling factor to the corresponding intermediate combining weight vector, and applying the final combining weights to the frequency-domain representation of the received signal.

9. The receiver circuit of claim 6, wherein the impairment estimation circuit is adapted to generate the frequency-domain representation of impairments to the desired signal by:
calculating a signal covariance for the received signal for each of the frequency bins;
computing an estimate of the desired signal contribution for each of the frequency bins, as a function of the frequency-domain representation of the channel response vectors; and,
for each frequency bin, subtracting the estimate of the desired signal contribution from the calculated signal covariance to obtain the impairment covariance matrix for the frequency bin.

10. The receiver circuit of claim 6, wherein the impairment estimation circuit is adapted to generate the frequency-domain representation of impairments to the desired signal by:
generating a parametric model of impairments for each frequency bin, as a function of estimated receiver noise, or channel response estimates corresponding to at least one interference source, or both, the parametric model for each frequency bin comprising at least one fitting parameter;
estimating a value for each fitting parameter, based on received signal samples; and
calculating the impairment covariance matrix for each frequency bin from the parametric models and the estimated values for the fitting parameters.
